(19) United States
(12) Patent Application Publication
(10) Pub. No.: US 2026/0350758 A1
(43) Pub. Date: Nov. 5, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: SHUHEI OGAWA, Saitama (JP)

(21) Appl. No.: 19/656,150

(22) Filed: Apr. 23, 2026

(30) Foreign Application Priority Data
May 2, 2025 (JP) 2025-076850

(51) Int. Cl. G06T 5/70; G06V 10/82

(52) U.S. Cl. CPC G06T 5/70; G06V 10/82

(57) ABSTRACT

An apparatus includes an acquisition unit configured to acquire input data including an image, a defocus amount estimation unit configured to estimate a defocus amount of a subject based on the input data, and a reliability estimation unit configured to estimate a reliability of the estimated defocus amount, wherein the reliability is estimated using learned data based on the estimated defocus amount and a ground-truth value of the defocus amount of a subject prepared in advance.

### BACKGROUND

### Field of the Technology

The aspect of the embodiments relates to an information processing apparatus, an information processing method, and a storage medium.

### Description of the Related Art

In imaging apparatuses typified by interchangeable-lens digital cameras and the like, it is necessary to accurately estimate information such as a distance from the imaging apparatus to a subject and a defocus amount of the subject so as to accurately focus on the subject.

Japanese Patent Application Laid-Open No. 2015-207090 discloses an invention for estimating a defocus amount corresponding to a distance from a subject, and improves the accuracy of defocus amount estimation by correcting the estimated defocus amount using a reliability.

However, because the reliability in the configuration disclosed in Japanese Patent Application Laid-Open No. 2015-207090 includes image regions other than the subject, it is not possible to accurately calculate the reliability with respect to the subject's defocus amount.

### SUMMARY

According to an aspect of the embodiments, there is provided an apparatus comprising: an acquisition unit configured to acquire input data including an image; a defocus amount estimation unit configured to estimate a defocus amount of a subject based on the input data; a reliability estimation unit configured to estimate a reliability of the estimated defocus amount; and a correction unit configure to correct the defocus amount based on the estimated defocus amount and the estimated reliability, wherein the reliability is estimated using learned data based on the estimated defocus amount and a ground-truth value of the defocus amount of a subject prepared in advance.

Further features of the disclosure will become apparent from the following description of exemplary embodiments (with reference to the attached drawings).

### BRIEF DESCRIPTION OF THE DRAWINGS

FIG. 1 is a diagram showing an example of a hardware configuration of an imaging apparatus as an information processing apparatus according to Embodiment 1 of the invention.

FIG. 2 is an explanatory diagram of a defocus amount according to Embodiment 1 of the disclosure.

FIG. 3 is a functional block diagram showing an example of a configuration of an imaging apparatus 10 according to Embodiment 1 of the disclosure.

FIG. 4 is a functional block diagram showing an example of a configuration of a defocus information estimation unit 301 according to Embodiment 1 of the disclosure.

FIG. 5 is an explanatory functional block diagram of an example of a configuration of an input data acquisition unit 401 according to Embodiment 1 of the disclosure.

FIG. 6 is a flowchart showing an example of a process of the defocus information estimation unit 301 according to Embodiment 1 of the disclosure.

FIG. 7 is a flowchart showing an example of an input data acquisition process in step S601.

FIG. 8 is a flowchart showing an example of a defocus amount estimation process in step S602.

FIG. 9 is a flowchart showing an example of a reliability estimation process in step S603.

FIG. 10 is a diagram showing an example of a configuration of a deep neural network according to Embodiment 1 of the disclosure.

FIG. 11 is an explanatory diagram of an example of a configuration of defocus information learning according to Embodiment 1 of the disclosure.

FIG. 12 is a flowchart showing an example of a process for learning a defocus amount and a reliability according to Embodiment 1 of the disclosure.

FIG. 13 is a flowchart showing an example of a loss calculation process in step S1202.

FIGS. 14A to 14D are explanatory diagrams of examples of input data according to Embodiment 1 of the disclosure.

FIGS. 15A and 15B are explanatory diagrams of a defocus range of a subject according to Embodiment 1 of the disclosure.

FIG. 16 is a flowchart showing an example of a process of a defocus amount correction unit 302 according to Embodiment 1 of the disclosure.

FIG. 17 is a diagram showing an example of a configuration of a deep neural network according to Embodiment 1 of the disclosure.

### DESCRIPTION OF THE EMBODIMENTS

Hereinafter, favorable modes of the disclosure will be described using embodiments with reference to the accompanying drawings. In each diagram, the same reference signs are applied to the same members or elements, and duplicate description will be omitted or simplified.

### Embodiment 1

In the embodiment, a case where an image focused on a subject is captured using an interchangeable-lens digital camera in consideration of the extent of the subject in a depth direction will be described.

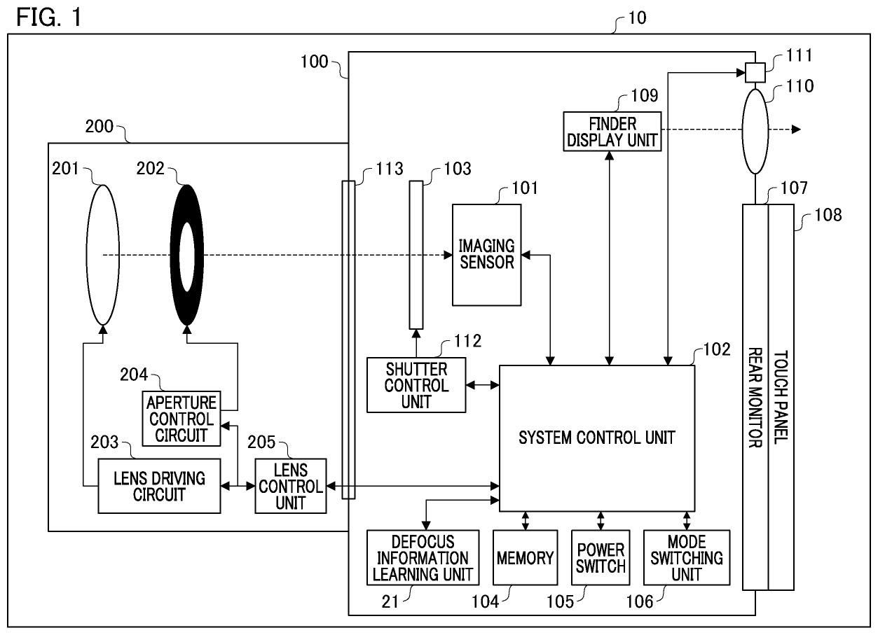

Hereinafter, Embodiment 1 of the disclosure will be described with reference to the drawings. FIG. 1 is a diagram showing an example of a hardware configuration of an imaging apparatus as an information processing apparatus according to Embodiment 1 of the disclosure, and is a block diagram showing main constituent elements of a system of an imaging apparatus (digital camera) 10. The configuration of the imaging apparatus according to Embodiment 1 of the disclosure will be described with reference to FIG. 1.

Further, some of the functional blocks shown in FIG. 1 are realized by causing a CPU or the like serving as a computer (not shown) included in the imaging apparatus to execute a computer program stored in a memory serving as a storage medium (not shown).

However, some or all of these function blocks may be realized by hardware. As the hardware, a dedicated circuit (ASIC), a processor (reconfigurable processor, DSP), or the like may be used.

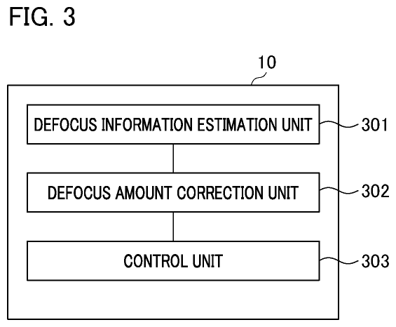

Also, each of the functional blocks shown in FIG. 1 does not necessarily need to be incorporated in the same housing, and may include separate devices connected to each other via signal paths. The description given above with reference to FIG. 1 also applies to FIGS. 3 to 5, 10, 11, and 17.

In FIG. 1, the imaging apparatus 10 serving as the information processing apparatus is, for example, an interchangeable-lens digital camera, and includes a camera body 100 and a lens unit 200 that guides incident light to an imaging sensor 101.

First, the camera body 100 will be described. The imaging sensor 101 includes, for example, a CMOS-type imaging sensor, and converts an optical signal, which is an optical image, into an electrical signal. An image of light rays incident on an imaging lens 201 is formed as an optical image on the imaging sensor 101 via an aperture 202 and a shutter 103.

A system control unit 102 controls the camera body 100 and includes a CPU or the like as a computer. The system control unit 102 further includes an image processing unit for video signals obtained by the imaging sensor 101.

Also, the system control unit 102 includes a phase-difference AF unit that performs a focus detection process using a phase-difference detection method on the basis of focus detection image data (phase-difference auto focus (AF) signal) obtained from the imaging sensor 101 and the image processing unit.

More specifically, the image processing unit generates, as the focus detection image data, a pair of image data items formed by light fluxes passing through a pair of pupil regions of the imaging optical system. The phase-difference AF unit detects a focus deviation amount on the basis of a deviation amount (phase difference) between the pair of image data items.

As described above, the phase-difference AF unit according to the embodiment performs phase-difference AF based on the output of the imaging sensor 101 (on-sensor phase-difference AF), without using a dedicated AF sensor. A memory 104 functions as a storage medium for storing computer programs, variables, constants, and the like for the operation of the system control unit 102.

Also, the memory 104 includes an electrically erasable and programmable nonvolatile memory, and stores various types of parameters, setting values such as ISO sensitivity, shooting modes, and various types of correction data.

The CPU serving as the computer in the system control unit 102 functions as a control means for controlling operations of respective parts of the entire image processing apparatus by executing computer programs stored in a storage medium such as the memory 104.

A power switch 105 switches a mode between power-on and power-off modes of the camera body 100. A mode switching unit 106 is a switch for setting and switching a mode between various types of shooting modes such as live-view shooting and video shooting.

A rear monitor 107 includes a liquid crystal device, an LED, or the like for displaying operation states using characters, images, sounds, and the like and shooting information using messages and the like in accordance with execution of programs in the system control unit 102.

A touch panel 108 is arranged in substantially the same area as the rear monitor 107, detects contact by a finger or a pen, notifies the system control unit 102 of a contact position for the rear monitor 107, and executes an operation or function associated with the contact position.

A finder display unit 109 displays shooting information in accordance with execution of computer programs by the system control unit 102, like the rear monitor 107, and configures an electronic viewfinder (EVF) together with an eyepiece lens 110.

Also, reference sign 111 denotes an eyepiece detection unit and, the system control unit 102 selectively displays the above-described shooting information on the rear monitor 107 or the finder display unit 109 in accordance with an eyepiece state of a photographer.

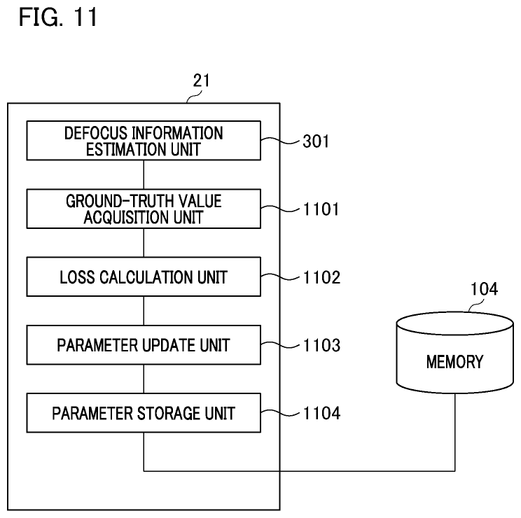

Furthermore, reference sign 21 denotes a defocus information learning unit, which is a unit for learning the reliability with respect to a defocus amount of each part of a subject. Details will be described below with reference to FIG. 11. Furthermore, the functions of the defocus information learning unit 21 may be realized by the system control unit 102. Also, the defocus information learning unit 21 may be provided inside the imaging apparatus 10 or outside the imaging apparatus.

Next, the configuration of the lens unit 200 will be described. The camera body 100 and the lens unit 200 are mechanically and electrically connectable via a lens mount mechanism 113, and are detachable.

The lens unit 200 includes an imaging lens 201, an aperture 202, a lens driving circuit 203, an aperture control circuit 204, a lens control unit 205, and the like. In FIG. 1, the imaging lens 201 is shown as a single lens for simplicity, but in practice, the imaging lens 201 includes a plurality of lens groups.

The lens control unit 205 controls the entire lens unit 200. The lens control unit 205 includes a CPU as a computer and includes a memory that stores various types of constants, variables, computer programs for lens operations, and the like. Also, the lens control unit 205 includes a nonvolatile memory that holds information specific to the lens unit, such as maximum and minimum aperture values and a focal length.

The system control unit 102 of the camera body 100 calculates a defocus amount using output information from the imaging sensor 101. Also, the system control unit 102 communicates with the lens control unit 205 of the lens unit 200 on the basis of the calculated defocus amount, and controls the lens driving circuit 203 to perform a focus adjustment and achieve focusing.

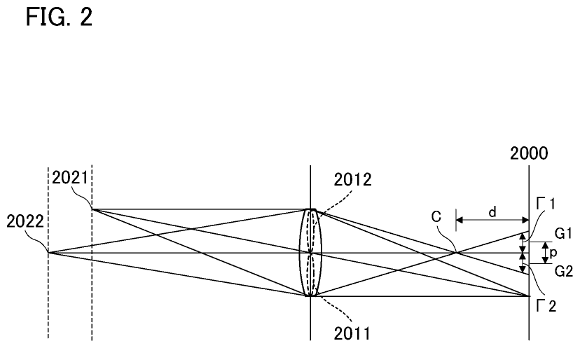

Next, the defocus amount used as image depth information in the embodiment will be described. FIG. 2 is an explanatory diagram of a defocus amount according to Embodiment 1 of the disclosure. A relationship between a defocus amount of the imaging optical system and a phase difference (image shift amount) between a first focus detection signal and a second focus detection signal obtained from the imaging sensor will be described with reference to FIG. 2.

In FIG. 2, an imaging plane 2000 is a light-receiving surface of an imaging sensor (not shown), and an exit pupil of the imaging optical system is divided into two pupil regions, i.e., a first pupil region 2011 and a second pupil region 2012. A defocus amount d corresponds to a distance (magnitude) from an image-forming position C of a light flux from the subject (2021 or 2022) to an imaging plane 2000.

In FIG. 2, a front-focus state (d<0) in which the image-forming position C is located on the subject side from the imaging plane 2000 is shown. In the rear-focus state in which the image-forming position C is located on the opposite side of the imaging plane 2000 from the subject, d>0.

Also, in a focused state in which the image-forming position C coincides with the imaging plane 2000, d=0. The imaging optical system is in a focused state (d=0) with respect to the subject 2021, and in a front-focus state (d<0) with respect to the subject 2022. The front-focus state (d<0) and the rear-focus state (d>0) are collectively referred to as a defocus state (|d|>0).

In the front-focus state (d<0), among the light fluxes from the subject 2022, the light flux passing through the first pupil region 2011 (second pupil region 2012) converges once and then spreads with a width Γ1 (Γ2) around a centroid position G1 (G2) of the light flux, thereby forming a blurred image on the imaging plane 2000.

This blurred image is received by first focus detection pixels (second focus detection pixels) included in pixels of the imaging sensor, and a first focus detection signal (a second focus detection signal) is generated. That is, the first focus detection signal (the second focus detection signal) represents a subject image of the subject 2022 that is blurred by the blur width Γ1 (Γ2) at the centroid position G1 (G2) of the light flux on the imaging plane 2000.

The blur width Γ1 (Γ2) of the subject image increases approximately in proportion to an increase in the magnitude |d| of the defocus amount d. Likewise, the magnitude |p| of an image shift amount p between the first focus detection signal and the second focus detection signal (=the difference G1-G2 between the centroid positions of the light fluxes) also increases approximately in proportion to an increase in |d|.

Also, in the rear-focus state (d>0), the image-shift direction between the first focus detection signal and the second focus detection signal is opposite to that in the front-focus state, but other aspects are similar.

As described above, as the magnitude of the defocus amount increases, the magnitude of the image shift amount between the first and second focus detection signals increases. In the embodiment, focus detection of an imaging surface phase difference detection method for calculating the defocus amount from the image shift amount (phase difference) between the first and second focus detection signals obtained using the imaging sensor 101 is performed.

Accordingly, in the phase-difference AF unit of the system control unit 102, as the magnitude of the defocus amount of the imaging signal increases, the magnitude of the image shift amount between the first focus detection signal and the second focus detection signal increases.

Furthermore, in the embodiment, the image shift amount is converted into a detected defocus amount using a conversion coefficient calculated on the basis of a baseline length. In this case, in the embodiment, as the unit of the defocus amount, a product [Fδ] of an F-number of the aperture of the optical system of the imaging apparatus at the time of image capture and an allowable confusion circle diameter 8 is used.

FIG. 3 is an explanatory functional block diagram of an example of a configuration of the imaging apparatus 10 according to Embodiment 1 of the disclosure. A defocus information estimation unit 301 estimates a defocus amount of a subject. Here, in the embodiment, the estimated defocus amount of the subject includes a value indicating a value range of defocus amounts possessed by the subject (a defocus range).

Furthermore, in relation to the defocus amount of the subject, a representative value of the defocus amounts possessed by the subject may be defined as the defocus amount. Examples of such a representative value include a maximum value, a minimum value, a median value, and an average value of the defocus range and the like. However, in the embodiment, the definition of the defocus amount of the subject to be estimated is not limited to these examples.

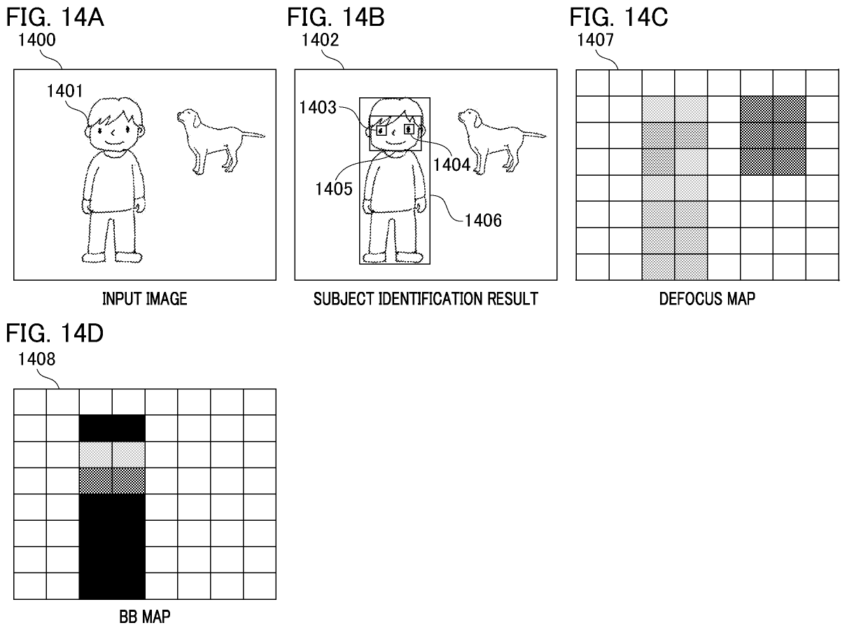

An example of a result obtained by imaging a person 1401 using the imaging apparatus 10 is shown in FIG. 14. FIGS. 14A to 14D are explanatory diagrams of examples of input data according to Embodiment 1 of the disclosure. In FIG. 14, reference sign 1400 denotes an image obtained by the imaging apparatus 10, and reference sign 1407 denotes a defocus amount corresponding to each region of the image 1400. A map indicating the defocus amount corresponding to each region in the image is referred to as a defocus map.

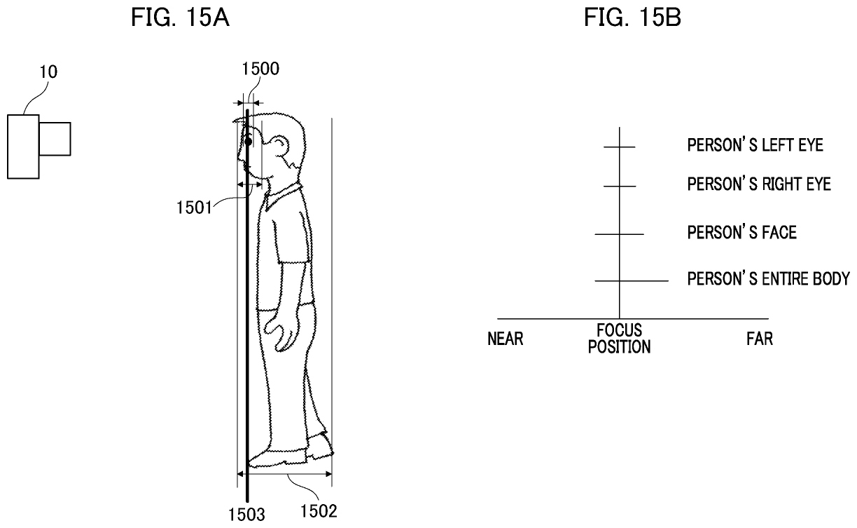

FIGS. 15A and 15B are explanatory diagrams of a defocus range of a subject according to Embodiment 1 of the disclosure. FIG. 15A is a diagram showing a range of a defocus amount for each part of the person 1401.

Reference sign 1500 denotes a distance range from the imaging apparatus 10 to the person's left eye, reference sign 1501 denotes a distance range from the imaging apparatus 10 to the person's face, and reference sign 1502 denotes a distance range from the imaging apparatus 10 to the person's entire body. Reference sign 1503 indicates a focus position of the imaging apparatus 10.

Also, FIG. 15B schematically shows estimated defocus ranges for the person's left eye, right eye, face, and entire body, in which the horizontal axis represents the magnitude of the defocus amount, with the side closer to the imaging apparatus 10 defined as near and the farther side defined as far.

In FIG. 15B, a length of each line segment represents a defocus range, which is a value range of defocus amounts. Furthermore, in one embodiment, it is only necessary for the subject to include one or more parts, and in the embodiment, the subject parts are not limited to the person's left eye, right eye, face, and entire body or the like.

In FIG. 15A, for example, in the distance range from the imaging apparatus 10 to the person's entire body, the nearest side is, for example, the tip of the person's nose, and the farthest side is, for example, the person's heel.

Accordingly, the maximum defocus amount (nearest value) of the defocus amounts of the person's entire body is the defocus amount corresponding to the tip of the person's nose, and the minimum defocus amount (farthest value) is the defocus amount corresponding to the person's heel. The value range defined by these values is the defocus range of the entire body of the person 1401.

In this manner, the defocus information estimation unit 301 recognizes estimation targets such as the subject's pupils, face, and entire body, and estimates a defocus range, which is a value range of defocus amounts, by taking into account near-far relationships of these targets in the depth direction. Furthermore, the defocus information estimation unit 301 of FIG. 3 estimates a reliability with respect to the estimated defocus amount (defocus range).

A defocus amount correction unit 302 corrects the defocus range on the basis of the defocus range obtained by the defocus information estimation unit 301 and the reliability.

A control unit 303 calculates a drive amount of the imaging lens 201 on the basis of the defocus range corrected by the defocus amount correction unit 302, and controls a focus position. Also, the control unit 303 adjusts the depth of field (DoF) by controlling (adjusting) the aperture 202.

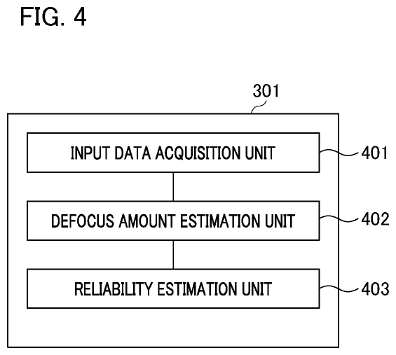

FIG. 4 is a functional block diagram showing an example of a configuration of the defocus information estimation unit 301 according to Embodiment 1 of the disclosure. An input data acquisition unit 401 acquires data necessary for estimating a defocus range of a subject. That is, the input data acquisition unit 401 acquires input data including an image. Details will be described below.

A defocus amount estimation unit 402 estimates a defocus amount (defocus range) of the subject on the basis of the input data obtained from the input data acquisition unit 401. A reliability estimation unit 403 estimates a reliability of the defocus amount (defocus range) of the subject estimated by the defocus amount estimation unit 402 on the basis of the data obtained from the input data acquisition unit 401.

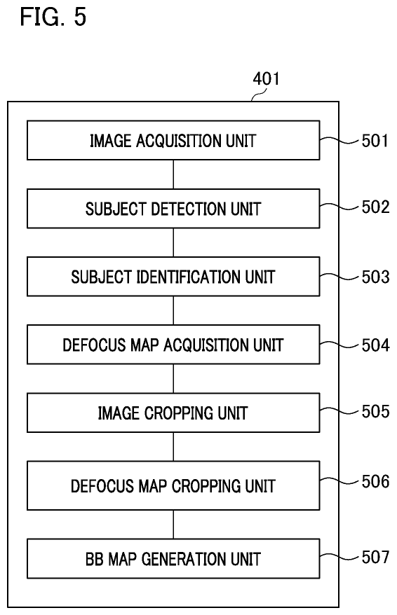

The defocus amount correction unit 302 of FIG. 3 corrects the defocus range of the subject estimated from the defocus amount estimation unit 402 of FIG. 4, on the basis of the reliability obtained from the reliability estimation unit 403 of FIG. 4. Details of the input data acquisition unit 401 are shown in FIG. 5.

FIG. 5 is a functional block diagram showing an example of a configuration of the input data acquisition unit 401 according to Embodiment 1 of the disclosure. As shown in FIG. 5, the input data acquisition unit 401 of FIG. 4 includes an image acquisition unit 501, a subject detection unit 502, a subject identification unit 503, a defocus map acquisition unit 504, an image cropping unit 505, a defocus map cropping unit 506, and a BB map generation unit.

The image acquisition unit 501 acquires an image captured by the imaging apparatus 10. The image is, for example, an image in which a person is captured, as shown by reference sign 1400 in FIG. 14. The subject detection unit 502 detects a subject from within the image obtained from the image acquisition unit 501 according to image recognition.

The subject is, for example, a person. In one embodiment, it is only necessary to use a method such as that described in Non-Patent Literature 1 (Liu, SSD: Single Shot Multibox Detector, In: ECCV 2016) and the like as a technique for detecting an object from an image, and a bounding box (hereinafter abbreviated as BB) indicating a region of the subject can be obtained by object detection.

Also, techniques for detecting a person's face and pupils include Non-Patent Literature 2 (RetinaFace: Single-stage Dense Face Localisation in the Wild. In: arXiv 2019) and the like. For example, in FIG. 14B, reference sign 1402 indicates an example of a BB of the person 1401 detected from the image 1400 of FIG. 14A. Reference sign 1403 denotes a BB of the right eye, reference sign 1404 denotes a BB of the left eye, reference sign 1405 denotes a BB of the face, and reference sign 1406 denotes a BB of the entire body.

The subject identification unit 503 identifies, from among the detected subjects, a subject that is desired to be in focus. As a method for determining the subject from within an image, there is a method in which the user touches a subject displayed on the rear monitor 107 via the touch panel 108 to determine the subject.

Furthermore, the subject is not limited to being designated via the touch panel 108, and may instead be automatically detected and determined as a main subject within the image. As a method for automatically detecting a main subject within an image, for example, a technique such as that described in Patent Literature 2 may be used.

The defocus map acquisition unit 504 acquires a defocus map corresponding to the image obtained by the imaging apparatus 10. The image cropping unit 505 crops a region in which the subject is captured from the image and resizes the cropped region to a predetermined size.

Like the image cropping unit 505, the defocus map cropping unit 506 crops a region in which the subject is captured from the defocus map and resizes the cropped region to a predetermined size. The BB map generation unit 507 generates a BB map on the basis of the BB information of the subject obtained by the subject identification unit 503.

Reference sign 1408 in FIG. 14D indicates an example of a BB map generated by the BB map generation unit 507. In the BB map, predetermined values are assigned to regions indicated by BBs of respective parts of the subject (for example, the BB of the right eye 1403, the BB of the left eye 1404, the BB of the face 1405, and the BB of the entire body 1406). The BB map does not necessarily need to be a single map, and separate maps may be provided for respective parts of the subject.

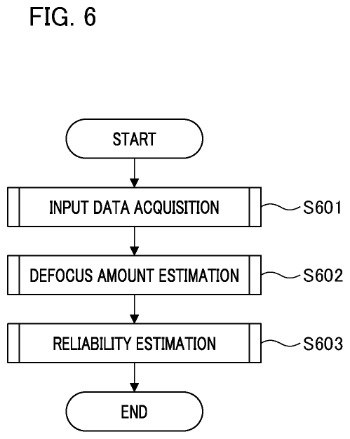

FIG. 6 is a flowchart showing an example of a process of the defocus information estimation unit 301 according to Embodiment 1 of the disclosure, and shows each process executed by the system control unit 102.

Furthermore, the operations of the respective steps of the flowchart in FIG. 6 are sequentially performed by the CPU or the like serving as the computer in the system control unit executing the computer program stored in a memory.

However, the imaging apparatus as an information processing apparatus does not necessarily need to perform all of the processing steps described in the flowchart.

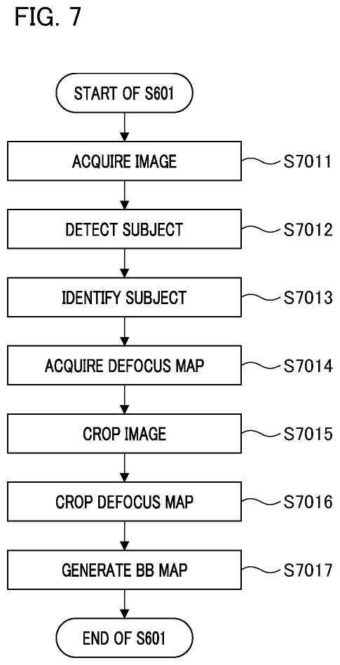

In step S601 of FIG. 6, the input data acquisition unit 401 acquires input data. Step S601 functions as an input data acquisition step of acquiring the input data including an image. Details of step S601 are shown in FIG. 7. FIG. 7 is a flowchart showing an example of the input data acquisition process in step S601.

The operations of the respective steps of the flowchart in FIG. 7 are sequentially performed by the CPU or the like serving as the computer in the system control unit executing the computer program stored in the memory.

In step S7011 of FIG. 7, the image acquisition unit 501 acquires a captured image. Subsequently, in step S7012, the subject detection unit 502 detects BBs of respective parts of the subject in the image. Subsequently, in step S7013, the subject identification unit 503 identifies a subject serving as an imaging target.

Subsequently, in step S7014, the defocus map acquisition unit 504 acquires a defocus map corresponding to the captured image. Subsequently, in step S7015, the image cropping unit 505 crops a partial region of the image based on the BB of the subject identified in step S7013, and resizes the cropped region to a predetermined size.

Subsequently, in step S7016, as in step S7015, the defocus map cropping unit 506 crops a partial region of the defocus map on the basis of the BB of the subject identified in step S7013, and resizes the cropped region to a predetermined size.

Subsequently, in step S7017, the BB map generation unit 507 generates a BB map as shown in FIG. 14D on the basis of the BB of the subject identified in step S7013.

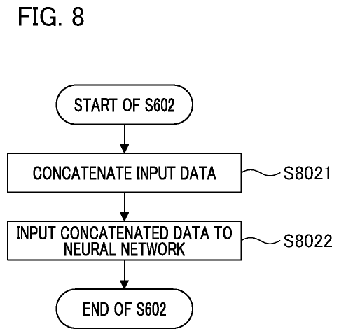

Subsequently, in step S602 of FIG. 6, the defocus amount estimation unit 402 estimates a defocus amount (defocus range) of the subject on the basis of the input data obtained in step S601. Furthermore, step S602 functions as a defocus amount estimation step of estimating a defocus amount of the subject on the basis of the input data. Details of step S602 are shown in FIG. 8.

FIG. 8 is a flowchart showing an example of a defocus amount estimation process in step S602. The operations of the respective steps of the flowchart in FIG. 8 are sequentially performed by the CPU or the like serving as the computer in the system control unit executing the computer program stored in the memory.

First, in step S8021 of FIG. 8, the defocus amount estimation unit concatenates (links) the image, which is the input data, the defocus map, and the BB map. In one embodiment, it is only necessary to concatenate the input data by concatenating (linking), for example, the data in a channel direction.

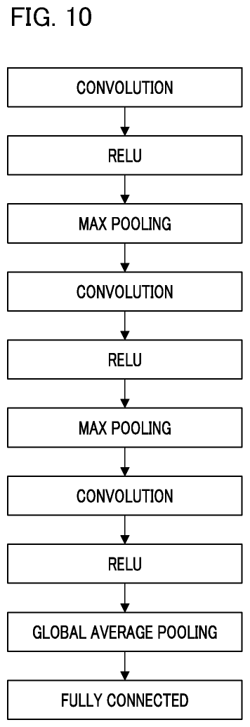

Subsequently, in step S8022, the concatenated (linked) input data is input to a neural network (hereinafter abbreviated as NN). An example of a configuration of the NN is shown in FIG. 10.

The NN includes a plurality of Convolution operations, non-linear operations such as ReLU and Max Pooling, Fully Connected, and the like.

An example of the processing flow of the NN will be described with reference to FIG. 10. In FIG. 10, after iterating a set of Convolution, ReLU, and Max Pooling processes multiple times, information in a spatial direction is compressed by Global Average Pooling.

Also, desired channels are obtained by Fully Connected. Furthermore, a Multilayer Perceptron may be used instead of Convolution, or Multi-head Self Attention may be used.

Furthermore, the NN in the embodiment is not limited to the configuration shown in FIG. 10. Also, in one embodiment, for the desired channels, it is only necessary to obtain a defocus range corresponding to each part of the subject. For example, when defocus ranges of four parts, i.e., right eye, left eye, face, and body, of the subject are to be obtained, because it is only necessary to obtain NN outputs for the near side and the far side of each of the four parts, it is sufficient to provide eight channels.

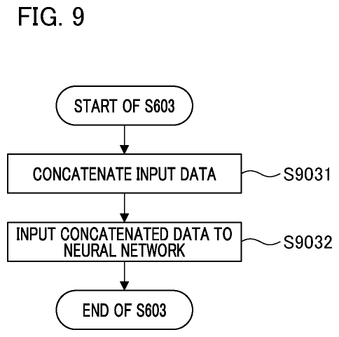

Subsequently, in step S603 of FIG. 6, the reliability estimation unit 403 estimates reliabilities corresponding to the defocus ranges of the respective parts estimated in step S602. Step S603 functions as a reliability estimation step of estimating a reliability of the defocus amount estimated in the defocus amount estimation step. Details of the processing of step S603 are shown in FIG. 9. FIG. 9 is a flowchart showing an example of a reliability estimation process in step S603.

The operations of the respective steps in the flowchart of FIG. 9 are sequentially performed by the CPU or the like serving as the computer in the system control unit executing the computer program stored in the memory.

First, in step S9031, the reliability estimation unit 403 concatenates (links) an image, which is input data, a defocus map, and a BB map. Furthermore, in one embodiment, the input data may be concatenated (linked) using only the image and the defocus map.

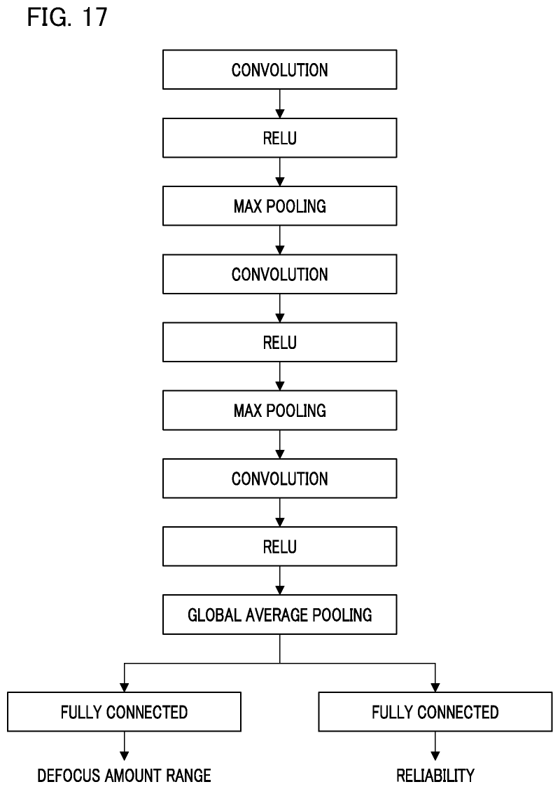

Subsequently, in step S9032, the reliability estimation unit 403 inputs the concatenated input data to the NN. FIG. 10 is a diagram showing an example of a configuration of a deep neural network according to Embodiment 1 of the disclosure, and the NN may have a configuration as shown in FIG. 10, as in step S8022. Also, the NN may have a configuration as shown in FIG. 17.

FIG. 17 is a diagram showing an example of a configuration of a deep neural network according to Embodiment 1 of the disclosure. In FIG. 17, a part of the NN input (step S8022) in the defocus amount estimation unit 402 and a part of the NN input (step S9032) in the reliability estimation unit 403 are shared. That is, the defocus amount estimation unit and the reliability estimation unit share a part or all of the input.

In FIG. 17, NN weights from the input layer to a Global Average Pooling layer are shared, and, in one embodiment, only a fully connected layer, which is the final layer, has different NN weights for defocus range estimation and reliability estimation.

As described above, in the embodiment, the defocus amount estimation unit and the reliability estimation unit include neural networks, and the computational cost can be reduced by sharing the NN used for defocus range estimation and reliability estimation. Furthermore, the NN weights shared between defocus range estimation and reliability estimation may be partially shared or entirely shared.

That is, the neural network included in the defocus amount estimation unit and the neural network included in the reliability estimation unit may share some or all of weights of the neural network.

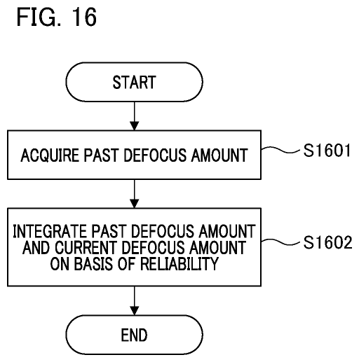

Next, the defocus amount correction unit 302 of FIG. 3 corrects the defocus range on the basis of the defocus range and the reliability obtained by the defocus amount estimation unit 402 and the reliability estimation unit 403 of FIG. 4. The processing flow of the defocus amount correction unit 302 is shown in FIG. 16.

FIG. 16 is a flowchart showing an example of a process of the defocus amount correction unit 302 according to Embodiment 1 of the disclosure. Furthermore, the operations of the respective steps in the flowchart of FIG. 16 are sequentially performed by the CPU or the like serving as the computer in the system control unit executing the computer program stored in the memory.

In FIG. 16, the defocus range is corrected on the basis of a past defocus range, a current defocus range, and the reliability obtained from the reliability estimation unit 403. That is, the defocus amount correction unit corrects the defocus amount on the basis of the reliability estimated by the reliability estimation unit and the past defocus amount and the current defocus amount of the subject obtained by the defocus amount estimation unit.

First, in step S1601, the defocus amount correction unit 302 acquires a past defocus range.

Subsequently, in step S1602, the defocus amount correction unit 302 corrects the current defocus range on the basis of the reliability, the past defocus range, and the current defocus range obtained from the defocus amount estimation unit 402.

For example, the defocus range (the near-side defocus amount and the far-side defocus amount) of each part may be corrected by performing calculations such as those expressed by formula (1) and formula (2).

$${D}_{imax}^{t} = ς ( {p}_{imax}^{t} ) {D}_{imax}^{t} - ( 1 - ς ( {p}_{imax}^{t} ) ) {D}_{imax}^{t - 1} \qquad ( 1 )$$

$${D}_{imin}^{t} = ς ( {p}_{imin}^{t} ) {D}_{imin}^{t} - ( 1 - ς ( {p}_{imin}^{t} ) ) {D}_{imin}^{t - 1} \qquad ( 2 )$$

Here,

$${D}_{imax}^{t}$$

defocus amount of the i-th part at time t and

$${D}_{imin}^{t}$$

denotes the far-side defocus amount of the i-th part at time t.

$${p}_{imax}^{t}$$

denotes the reliability corresponding to the near-side defocus amount of the i-th part at time t and

$${p}_{imin}^{t}$$

denotes the reliability corresponding to the far-side defocus amount of the i-th part at time t. Furthermore, ζ(⋅) denotes a sigmoid function defined by the following formula (3).

$$ς ( x ) = \frac{1}{1 + {e}^{- x}} \qquad ( 3 )$$

As described above, the defocus amount correction unit 302 can obtain a corrected defocus range for each part of the subject.

The control unit 303 can calculate a drive amount of the imaging lens 201 to control a focus position on the basis of the defocus range of each part of the subject obtained from the defocus amount correction unit 302. Also, by controlling (adjusting) the aperture 202, the depth of field (DoF) can be adjusted.

In the embodiment, the defocus amount estimation unit estimates defocus amounts corresponding to one or more parts of the subject, and the reliability estimation unit estimates reliabilities corresponding to the defocus amounts of one or more parts of the subject.

Because the defocus amount correction unit 302 corrects the defocus range estimated by the defocus information estimation unit 301 on the basis of the reliability for the defocus amount of each part, more accurate adjustment of the lens driving amount becomes possible.

That is, because the defocus amount correction unit 302 corrects the defocus amount on the basis of the defocus amount estimated by the defocus information estimation unit 301 and the reliability estimated by the reliability estimation unit 403, it becomes easier to focus on any part of the subject.

Next, a configuration for learning the reliability corresponding to the defocus amount of each part of the subject will be described. FIG. 11 is a diagram showing an example of a configuration of the defocus information learning unit 21 (see FIG. 1) according to Embodiment 1 of the disclosure. Furthermore, as described above, the defocus information learning unit 21 may be provided inside the imaging apparatus 10 or may be provided outside the imaging apparatus.

As in the case of inference, the defocus information estimation unit 301 receives an image, a defocus map, and a BB of the subject as inputs, and estimates the defocus range of each part of the subject and the reliability corresponding to the estimated defocus range.

A ground-truth value acquisition unit 1101 acquires correct answer labels of the defocus range for each part of the subject.

Furthermore, in relation to the images prepared as learning data or the defocus range serving as a correct answer label, in one embodiment, it is only necessary to calculate a defocus amount for each focus detection region from the focus detection signals acquired simultaneously with image acquisition and to use the calculated defocus amount.

The calculation of the defocus amount may be performed within the imaging apparatus, or the focus detection signals and image signals may be recorded together and the defocus amount may be calculated by an external arithmetic device such as a personal computer.

When a correct answer defocus range is associated with an image, in one embodiment, it is only necessary to determine an appropriate range as a correct answer for the defocus amount of a subject part by considering the region of the subject part in the image and the defocus amounts of the background or foreground obstacles.

Such work may be performed while being visually checked by a person. Also, the image may be divided by segmentation, and the defocus amount calculated in a region where a focus detection region overlaps a region of each subject part that does not include background or foreground obstacles may be regarded as a correct defocus amount, and a range may be calculated based thereon.

A loss calculation unit 1102 compares the estimation result output from the defocus information estimation unit 301 with the correct answer labels acquired by the ground-truth value acquisition unit 1101, and calculates a loss.

A parameter update unit 1103 updates parameters of the defocus information estimation unit 301 on the basis of the loss obtained by the loss calculation unit 1102.

A parameter storage unit 1104 stores the parameters of the defocus information estimation unit 301 in the memory 104.

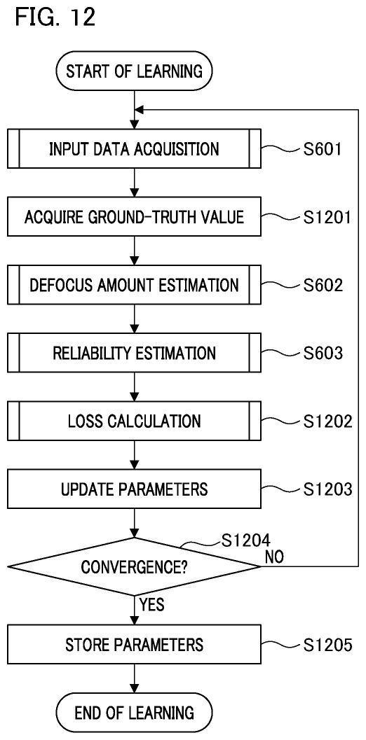

A flowchart for learning the defocus range and reliability is shown in FIG. 12. FIG. 12 is a flowchart showing an example of a process for learning defocus amounts and reliabilities according to Embodiment 1 of the disclosure.

The operations of the respective steps in the flowchart of FIG. 12 are sequentially performed by the CPU or the like serving as the computer in the system control unit executing the computer program stored in the memory.

The flow of the processing of steps S601 to S603 is similar to that of the process shown in FIG. 6 during inference.

In step S1201, the ground-truth value acquisition unit 1101 acquires correct answer labels of the defocus range for each part of the subject. The correct answer labels indicate, as shown in FIG. 15B, ground-truth values of near-side and far-side defocus values for each part of the subject.

Subsequently, in step S1202, the loss calculation unit 1102 calculates a loss for the defocus range and a loss for the reliability.

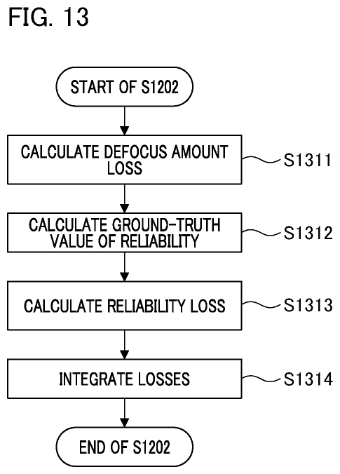

An example of a detailed process of step S1202 is shown in FIG. 13. FIG. 13 is a flowchart showing an example of a process for loss calculation in step S1202. Furthermore, the operations of the respective steps in the flowchart of FIG. 13 are sequentially performed by the CPU or the like serving as the computer in the system control unit executing the computer program stored in the memory.

First, in step S1311, the loss calculation unit 1102 calculates a loss for the defocus range. The loss for the defocus range is calculated on the basis of the estimated defocus range obtained in step S602 of FIG. 12 and the correct answer labels of the defocus range obtained in step S1201. The loss may be obtained, for example, using an L1 norm as expressed by the following formula (4).

$${Loss}_{defocus} = \frac{1}{N} {\sum }_{n}^{N} \vert {GT}_{i}^{max} - {D}_{i}^{max} \vert \qquad ( 4 )$$

Here, N denotes the number of subject parts,

$${GT}_{i}^{min}$$

denotes a near-side ground-truth defocus value of an i-th part,

$${D}_{i}^{max}$$

denotes an estimated near-side defocus value of the i-th part,

$${GT}_{i}^{max}$$

denotes a far-side ground-truth defocus value of the i-th part, and

$${D}_{i}^{min}$$

denotes an estimated far-side defocus value of the i-th part. That is, in the embodiment, the defocus amount estimation unit estimates near-side and far-side defocus amounts of the subject.

Subsequently, in step S1313 of FIG. 13, the loss calculation unit 1102 calculates a ground-truth value of reliability on the basis of the estimated value of the defocus range obtained in step S602 and the correct answer labels of the defocus range obtained in step S1201.

That is, the reliability estimation unit generates a ground-truth value of the reliability to be learned on the basis of the defocus amount estimated by the defocus amount estimation unit and a ground-truth value of the defocus amount of the subject prepared in advance.

The ground-truth value of reliability is set to a high value if the estimated value of the defocus range is close to the correct answer label. Furthermore, the ground-truth value of the reliability may be calculated, for example, as a discrete value of 1 or 0 as expressed by formula (5).

$$GTrel ( GT , D ) = \{ \begin{matrix}1 if \vert GT - D \vert < TH \\ 0\end{matrix} \qquad ( 5 )$$

Here, Th denotes a threshold for an error between the ground-truth value of the defocus range and the estimated value, and is empirically determined in consideration of an allowable deviation degree for the ground-truth value of the defocus range that has been estimated.

Ground-truth values

$${GTrel}_{i}^{max} and {GTrel}_{i}^{min}$$

of the reliability for the defocus range of an i-th part may be calculated, for example, as expressed by the following formulas (6) and (7) using formula (5).

$${GTrel}_{i}^{max} = GTrel ( {GT}_{i}^{max} , {D}_{i}^{max} ) \qquad ( 6 )$$

$${GTrel}_{i}^{min} = GTrel ( {GT}_{i}^{min} , {D}_{i}^{min} ) \qquad ( 7 )$$

According to formulas (5) to (7), the ground-truth value of the reliability to be learned is set to 1 when the estimated value of the defocus range is close to the correct answer and is set to 0 otherwise. That is, the ground-truth value of the reliability is configured to increase as the error between the defocus amount estimated by the defocus amount estimation unit and the ground-truth value of the defocus amount decreases.

Subsequently, in step S1313, the loss calculation unit 1102 calculates a loss for the reliability. The loss for the reliability is calculated on the basis of the estimated value of the reliability obtained in step S603 and the ground-truth value of the reliability obtained in step S1313. The loss may be calculated, for example, as expressed by the following formula (8).

$${Loss}_{rel} = \frac{1}{N} {\sum }_{n}^{N} CE ( {GTrel}_{i}^{max} , {p}_{i}^{max} ) + CE ( {GTrel}_{i}^{min} , {p}_{i}^{min} ) \qquad ( 8 )$$

Here,

$${p}_{i}^{max}$$

denotes an estimated reliability corresponding to an estimated near-side defocus value of the i-th part and

$${p}_{i}^{min}$$

denotes and estimated reliability corresponding to an estimated far-side defocus value of the i-th part. In this manner, the reliability estimation unit estimates reliabilities corresponding to near-side and far-side defocus amounts of the subject. Also, CE(⋅,⋅) denotes cross entropy, and is defined, for example, by the following formula (9).

CE(GT,p)=−GT log(ζ(p))−(1−GT)log(1−ζ(p)) (9)

Subsequently, in step S1314, the loss calculation unit 1102 integrates the loss for the defocus range and the loss for the reliability. That is, for example, the losses are integrated and a total loss is calculated as expressed by the following formula (10).

Loss=αLossdefocus+βLossrel Loss=αLoss_{defocus}+βLossᵣₑₗ (10)

Here, α and β are weights for balancing the loss for the defocus range and the loss for the reliability, respectively, and are empirically determined by a user. Alternatively, they may be determined by machine learning.

Subsequently, in step S1203 of FIG. 12, the parameter update unit 1103 updates a parameter on the basis of the loss calculated in step S1202. Here, the parameter is a weight of an element such as convolution in the neural network. A parameter updating process is performed on the basis of error backpropagation using, for example, Momentum SGD or the like.

In step S1204, it is determined whether or not the loss obtained by the loss calculation unit 1102 has converged. If it is determined that the loss has converged, the parameter storage unit 1104 stores parameters of the defocus information estimation unit 301 in step S1205.

After the parameters are stored in step S1205, the learning processing flow shown in FIG. 12 ends.

When “No” is determined in step S1204, the process returns to step S601. It may be determined to have converged, for example, when the loss falls below a predetermined value, when the number of iterations of steps S601 to S1203 exceeds a predetermined number, and the like, in relation to convergence of learning.

The subject is not limited to a single type. The subject may be not only a person but also an animal such as a dog or a cat, or a vehicle such as a car or a train, or a combination thereof. The embodiment does not limit the category of the subject.

In the embodiment, the defocus amount correction unit 302 corrects the defocus range of each part of the subject obtained by the defocus amount estimation unit 402 on the basis of the reliability obtained from the reliability estimation unit 403. As a result, by adopting defocus amounts having a higher reliability, the accuracy of the estimated defocus range is improved.

Thereby, accurate focusing on the subject becomes easier. Furthermore, in step S1313, the loss calculation unit 1102 calculates a loss for the reliability on the basis of the estimated defocus range and the ground-truth value of the defocus range, such that the calculated loss is used for learning.

That is, the reliability estimation unit in the embodiment is trained on the basis of the defocus amount estimated by the defocus amount estimation unit and a pre-prepared ground-truth value of the defocus amount of the subject. Accordingly, it becomes possible to accurately estimate reliability. As the accuracy of reliability is improved, the accuracy of the corrected defocus range is also likely to be improved.

### Modification Example 1 of Embodiment 1

In Embodiment 1, as shown in formula (5), the ground-truth value of the reliability is calculated to be 1 if the estimated value of the defocus range is close to the ground-truth value of the defocus range and is calculated to be 0 if it is far therefrom. On the other hand, as shown in formula (11), the ground-truth value of the reliability may be a continuous value.

$$GTrel ( GT , D ) = \frac{1}{1 + {e}^{α ( - \vert GT - D \vert + Th )}} \qquad ( 11 )$$

By continuously varying the ground-truth value of the reliability in this manner, a process for learning a higher reliability value as the estimated value of the defocus range is closer to the ground-truth value and learning a lower reliability value as it is farther therefrom is enabled, thereby further improving the accuracy of reliability.

### Modification Example 2 of Embodiment 1

In Embodiment 1, in step S1602 of FIG. 16, the defocus amount correction unit 302 corrects the current defocus range on the basis of the reliability, the past defocus range, and the current defocus range obtained from the defocus amount estimation unit 402.

However, correction of the defocus range may alternatively be performed by cutting off the reliability on the basis of a predetermined threshold. For example, using a function t defined by the following formula (12), the defocus range may be corrected as expressed by formulas (13) and (14).

$$τ ( x ) = \{ \begin{matrix}ς ( x ) if x > Th \\ 0 esle\end{matrix} \qquad ( 12 )$$

$${D}_{imax}^{t} = τ ( {p}_{imax}^{t} ) {D}_{imax}^{t} - ( 1 - τ ( {p}_{imax}^{t} ) ) {D}_{imax}^{t - 1} \qquad ( 13 )$$

$${D}_{imin}^{t} = τ ( {p}_{imin}^{t} ) {D}_{imin}^{t} - ( 1 - τ ( {p}_{imin}^{t} ) ) {D}_{imin}^{t - 1} \qquad ( 14 )$$

The threshold Th is a value empirically determined to improve the accuracy of defocus range estimation. By cutting off the reliability on the basis of the threshold, when the defocus range estimation result includes noise, it becomes possible to perform selection without using that defocus range estimation result, thereby enabling robust defocus range estimation.

### Modification Example 3 of Embodiment 1

In Embodiment 1, in step S1602, the defocus amount correction unit 302 corrects the current defocus range on the basis of the reliability, the past defocus range, and the current defocus range obtained from the defocus amount estimation unit 402.

However, correction of defocus range estimation may be performed by correcting a defocus range estimation result for a part with low reliability on the basis of a defocus range estimation result for a part with high reliability. For example, the defocus range estimation result for a part with low reliability may be replaced with the defocus range estimation result for a part with high reliability.

Also, in the correction of the defocus range estimation, the defocus amount on the side having the lower reliability between the reliability for the near-side defocus amount and the reliability for the far-side defocus amount may be corrected on the basis of the defocus amount on the side having the higher reliability.

### Modification Example 4 of Embodiment 1

In Embodiment 1, in step S1602, the defocus amount correction unit 302 corrects the current defocus range on the basis of the reliability, the past defocus range, and the current defocus range obtained from the defocus amount estimation unit 402.

However, correction of the defocus amount may be performed by machine learning using, for example, a neural network and the like. In one embodiment, it is only necessary to input the current defocus amount and its reliability, and the past defocus amount and its reliability in relation to inputs to the neural network.

A machine learning model such as a neural network is trained on the basis of ground-truth values of defocus amounts of subjects prepared in advance. The machine learning model is not limited to a neural network, and may be linear regression, support vector regression, or the like. In the embodiment, the machine learning model is not limited.

As described above, according to the above embodiments, by learning the reliability on the basis of the estimated defocus amount and the ground-truth values of defocus amounts of subjects prepared in advance, it is possible to accurately estimate the reliability with respect to the defocus amount of a subject. Also, a signal processing apparatus that improves the reliability of defocus amount estimation can be realized.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s).

The computer may comprise one or more processors (e.g., central processing unit (CPU), micro processing unit (MPU)) and may include a network of separate computers or separate processors to read out and execute the computer executable instructions.

The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

This application claims the benefit of Japanese Patent Application No. 2025-076850, filed on May 2, 2025, which is hereby incorporated by reference herein in its entirety.

What is claimed is:

1. An apparatus comprising:
at least one processor; and
at least one memory coupled to the at least one processor storing instructions which, when executed by the at least one processor, cause the apparatus to function as:
an acquisition unit configured to acquire input data including an image;
a defocus amount estimation unit configured to estimate a defocus amount of a subject based on the input data;
a reliability estimation unit configured to estimate a reliability of the estimated defocus amount; and
a correction unit configure to correct the defocus amount based on the estimated defocus amount and the estimated reliability;
wherein the reliability is estimated using a neural network trained based on the estimated defocus amount and a ground-truth value of the defocus amount of a subject prepared in advance.

2. The apparatus according to claim 1, wherein a ground-truth value of the reliability to be learned is generated based on the estimated defocus amount and the ground-truth value of the defocus amount of the subject prepared in advance.

3. The apparatus according to claim 2, wherein the ground-truth value of the reliability is a discrete value.

4. The apparatus according to claim 2, wherein the ground-truth value of the reliability is a continuous value.

5. The apparatus according to claim 2, wherein the ground-truth value of the reliability increases as an error between the estimated defocus amount and the ground-truth value of the defocus amount decreases.

6. The apparatus according to claim 1, wherein the defocus amount is corrected based on the estimated reliability, a past defocus amount of the subject, and a current defocus amount of the subject.

7. The apparatus according to claim 1, wherein defocus amounts corresponding to one or more portions of the subject are estimated.

8. The apparatus according to claim 7, wherein reliabilities corresponding to defocus amounts of one or more parts of the subject are estimated.

9. The apparatus according to claim 1, wherein a near-side defocus amount and a far-side defocus amount of the subject are estimated.

10. The apparatus according to claim 9, wherein reliabilities corresponding to the near-side defocus amount and the far-side defocus amount of the subject are estimated.

11. The apparatus according to claim 1, wherein a neural network for estimating the defocus amount and a neural network for estimating the reliability share some or all of weights of the neural networks.

12. A method comprising:
acquiring input data including an image;
estimating a defocus amount of a subject based on the input data;
estimating a reliability of the estimated defocus amount; and
correcting the defocus amount based on the estimated defocus amount and the estimated reliability;
wherein the reliability is estimated using learned data based on the estimated defocus amount and a ground-truth value of the defocus amount of a subject prepared in advance.

13. The method according to claim 12, wherein a ground-truth value of the reliability to be learned is generated based on the estimated defocus amount and the ground-truth value of the defocus amount of the subject prepared in advance.

14. The method according to claim 12, wherein the defocus amount is corrected based on the estimated reliability, a past defocus amount of the subject, and a current defocus amount of the subject.

15. The method according to claim 12, wherein a neural network for estimating the defocus amount and a neural network for estimating the reliability share some or all of weights of the neural networks.

16. A non-transitory computer-readable storage medium storing a computer program including instructions for executing the processes for:
acquiring input data including an image;
estimating a defocus amount of a subject based on the input data;
estimating a reliability of the estimated defocus amount; and
correcting the defocus amount based on the estimated defocus amount and the estimated reliability;
wherein the reliability is estimated using learned data based on the estimated defocus amount and a ground-truth value of the defocus amount of a subject prepared in advance.

17. The non-transitory computer-readable storage medium according to claim 16, wherein a ground-truth value of the reliability to be learned is generated based on the estimated defocus amount and the ground-truth value of the defocus amount of the subject prepared in advance.

18. The non-transitory computer-readable storage medium according to claim 16, wherein the defocus amount is corrected based on the estimated reliability, a past defocus amount of the subject, and a current defocus amount of the subject.

19. The non-transitory computer-readable storage medium according to claim 16, wherein a neural network for estimating the defocus amount and a neural network for estimating the reliability share some or all of weights of the neural networks.
